(19) United States
(12) Patent Application Publication
(10) Pub. No.: US 2014/0051033 A1
(43) Pub. Date: Feb. 20, 2014

(54) ALVEOLAR BONE SHAPE AND DIRECTION DISPLAY DEVICE, AND MEASURING METHOD USING SAME

(71) Applicant: Je-Won Wang, Yuseong-gu (KR)

(72) Inventor: Je-Won Wang, Yuseong-gu (KR)

(21) Appl. No.: 14/113,915

(22) PCT Filed: Apr. 25, 2012
(86) PCT No.: PCT/KR2012/003175

§ 371 Date: Nov. 12, 2013

(30) Foreign Application Priority Data
Apr. 26, 2011 (KR) 10-2011-0039136
May 30, 2011 (KR) 10-2011-0051498

(51) Int. Cl. A61C 19/04; A61C 8/00

(52) U.S. Cl. CPC A61C 19/042; A61C 8/00
USPC 433/72; 433/215

(57) ABSTRACT

The present invention relates to an alveolar bone shape and a direction display device, and a measuring method using the same where direction display device includes: a main body; a gum insertion fixing part connected to a fixed plate of the main body; a plurality of pin through holes or cut-out lines defined in a fixed plate central position disposed on a center of the main body; and a plurality of bone shape displays inserted into upper portions of the plurality of pin through holes or cut-out lines and the bone shape displays include a bone shape display part having a plate shape, and one to twelve bone shape display pin parts installed on a lower portion of the bone shape display part.

### TECHNICAL FIELD

Embodiment of the present invention comprises of alveolar bone structure, direction display device, measurement method that makes use of the device that helps locate the spot for the implant accurately during the implant procedure by measuring the outline of the alveolar bone through measuring the bone structure display device outline done by penetrating several bone structure display devices in the cutting line that had been installed in the body.

### BACKGROUND ART

Implant related technology spread rapidly and is currently one of the general practices in the field of dentistry. Implant procedure refers to the procedure that places prosthetic tooth in the place where tooth has been lost or missing and installs the prosthetics in the head of the implant tooth. This helps the tooth maintain its natural functions as much as possible without damaging the teeth or the organs surrounding it.

Surgical procedure for implant is divided into two categories of soft tissue surgery and bone cutting surgery. Basic of the soft tissue surgery is not very different from regular periodontal surgery but there are special techniques that are required in order to supplement the soft tissues when they are in lack. Bone cutting surgery goes through the process of cutting the cortical bone and cancellous bone. Basic principle is that a small home is drilled and then it will be widened gradually until it almost matches the diameter of the implant or little smaller than this. After this, the implant tooth is placed in. Through the implant related procedure, implant is placed in the dental root which will replace the missing tooth of the patient to function in its place.

Korea Patent Publication No. 1020100119593 discloses information regarding the first measurement that makes it possible to insert the hole in alveolar bone made through the drilling, second measurement that makes it possible to be combined with above mentioned first measurement in vertical direction at the bottom has been provided. Information regarding third measurement which includes alveolar bone measurement point is also disclosed.

Korea Patent Publication No. 1020090040660 discloses information regarding the node in the neb and that in the latter part, there is a dielectric comprised of dielectric material. The information regarding probe that comes equipped with length indicator and the first electrode connected to above mentioned probe as well as the first electrode that connects to above mentioned probe and the human lips which is composes of electrode which is the second electrode is provided.

Also, the information on maxillary sinus bone thickness measurement device which includes controller unit that decides and indicates the subject's resistance value wherein the subject is connected through the electrode by above mentioned electrode and the information on how to measure by using it is also disclosed.

Korea Patent Publication No. 1009372420000 discloses that insertion terminal that includes the foreign body which is inserted into the alveolar bone that includes inside of the body that is inserted into the foreign body as well as the insertion terminal that connects the foreign body is connected to the foreign body and inside of the body selectively.

Information that discloses fixed terminal that connects to part of the human body and the alveolar bone measurement point that includes controller unit that measures subject's resistance value which is connected to insertion and fixed terminal in order to decide if whether the subject has conductance had also been made public.

### DISCLOSURE

### Technical Problem

As based on the prior art, implant procedure was conducted by exposing the bone by forming the flap that involves cutting the gum in order to find out about the shape and the direction of the bone which provides information regarding the shape and the direction of the alveolar bone. This type of method causes great pain and slows down the recovery process of the patient as it involves incision and suturing the soft tissue. Moreover, time it takes a long time to perform the procedure which causes significant amount of stress for both the patient and the doctor performing the procedure. Thus, this will greatly help the patient and the doctor to perform the procedure that does not involve incisions. The problem at hand is that expensive equipment such as CT scanner should be used in order to figure out the shape and the direction of the bone. Moreover, problem that arises when the scanner provides distorted images which gives no other alternatives but to perform an invasive procedure that involves incisions.

### Technical Solution

In order to resolve the problem as stated above, this invention helps figure out the direction and shape of the bone without having to form the flap through gum incision. This also eliminates image distortion and the error that may occur during CT scan as well as making it possible to check the shape and direction of the bone by installing it in the patient's mouth. Solution to the problem that this invention seeks to achieve is to enable the implant procedure by looking at the alveolar bone structure and the direction display device directly in the mouth which makes it possible to check the direction and the shape of the bone by forming a hole in the gum without having to make severe incisions and to provide measurement method which makes use of alveolar bone structure and the direction display device tool.

### Advantageous Effects

Current invention increases the level of accuracy by performing the implant procedure without gum incision by checking the shape and direction of the bone by installing the shape and the direction of the bone by directly installing it in the patient's mouth. Prior art of implant method involved exposure of the bone and severe incisions but this method is more advantageous as it improves accuracy without incisions and provides faster recovery time and less pain as it creates a hole in the gum on the implant spot only. Moreover, this type of less invasive procedure involves high priced CT scanner in which there is also the risk of inaccurate procedure due to error in the image from the scanner. Current invention prevents this type of disadvantages and provides the economic advantage over expensive treatments.

### BRIEF DESCRIPTION OF DRAWINGS

The preferred embodiments of the present invention will be described with reference to the accompanying drawings.

FIG. 1 is a whole diagram illustrating the embodiment of alveolar bone structure and direction display device according to the present invention.

FIG. 2 is a detail view illustrating an embodiment of alveolar bone structure and direction display device according to the present invention.

FIG. 3 is a detail view illustrating the bone structure display device and alveolar bone structure and direction display device according to the present invention.

FIG. 4 is the usage indicator illustrating an embodiment of alveolar bone structure and direction display device according to the present invention.

Front diagram (4(A), detail view of the surface (4(B), cross section of the detailed side elevation view (4(C) according to the present invention.

FIG. 5 is another example of detail view illustrating the embodiment of bone structure display, alveolar bone structure and direction display device according to the present invention.

FIGS. 6 and 7 is a diagram of the body illustrating the embodiment of alveolar bone structure and direction display device according to the present invention.

FIG. 8 is a bone structure display device illustrating the embodiment of provides the information regarding usage of alveolar bone structure and direction display device according to the present invention.

FIG. 9 is a general diagram illustrating the embodiment of alveolar bone structure and measurement device according to the present invention.

FIG. 10 is a detailed diagram illustrating the embodiment of the disassembled alveolar bone measurement device of this invention according to the present invention.

FIG. 11 is a usage indicator illustrating the embodiment of alveolar bone measurement device according to the present invention

FIG. 12 is another detailed diagram illustrating the embodiment of fastening plate according to the present invention.

FIGS. 13 and 14 is another detailed diagram illustrating the embodiment of fastening plate according to the present invention.

FIG. 15 is a usage indicator illustrating the illustrating the embodiment of alveolar bone measurement device according to the present invention.

### BEST MODE

Several bone structure display devices from the top of the gum to the bottom should be inserted on the spot where implant procedure is about to take place after the tooth has been removed from top to bottom of the gum. One or twelve pin fasteners for bone structure device should be inserted until the alveolar bone would be reached which is installed in the lower part of the bone structure display part. After observing the shape of bone structure indicator, doctor will measure the shape and the distance of alveolar bone and perform the implant procedure in the right area after making the incision on the right spot.

### Detailed Description of Preferred Embodiments

The preferred embodiments of the present invention will be described with reference to the accompanying drawings.

Embodiment of the present invention consists of the body 200, fastening plate for the gum 25 which is connected to the body 200 fastening plate 20, several pin penetration holes 23 or cutting lines 24 in the fastening plate's central area 23 which is located at the center of body as mentioned above 200 and several bone structure display devices 4 that will be inserted on the top of the pin penetration holes 23 or cutting lines 24 that had been mentioned above. The measurement method using alveolar bone structure and direction indicator device which is comprised of bone structure display device 4 made from board shaped bone structure display device part 10 and one or up to twelve pin fasteners for bone structure device 11.

Other embodiments of the current invention are comprised of ∩ shaped fastening plate, upper fastening plate which will be installed in the top part of the above mentioned fastening plate, and two fastening plates' sides that will be installed on the lower part of both sides of the above mentioned upper fastening plate.

The description of current invention also illustrates several pin penetration holes and several bone structure display devices that are inserted above the above mentioned pin penetration holes and the screw penetration holes that are installed below the center of above mentioned fastening plate's side, screws that are inserted to above mentioned screw penetration holes and above mentioned bone structure display device made from board shaped bone structure display device and the bone structure display's pin penetration holes installed in the lower part of the above mentioned bone structure display device.

Current invention inserts the bone structure display device which will be inserted to the alveolar bone of the patient undergoing the implant procedure so that the implant procedure may proceed effectively without incision of the gums by observing the bone structure display device's bone structure display unit that measures the structure of alveolar bone.

Embodiment of the present invention is designed so that the body induces the location of the bone structure display device and another function is to fix the bone structure display device and top insert the bone structure display device that will measure the shape of the alveolar bones. Through this procedure, the doctor can observe the shape of alveolar bones with the bone structure display device. With the current invention's embodiment that provides the method for doctor to measure the alveolar bones, the doctor can then decide the location that needs the implant procedure, its angle and other directions needed for the procedure. This also minimizes the amount of pain felt by the patient as it forms a single hole for the implant instead of severe gum incision.

Embodiment of the current invention consists of body and the bone structure display device. There is a method that can check the structure of the alveolar bone or the structure of the alveolar bone can be checked by the bone structure display device.

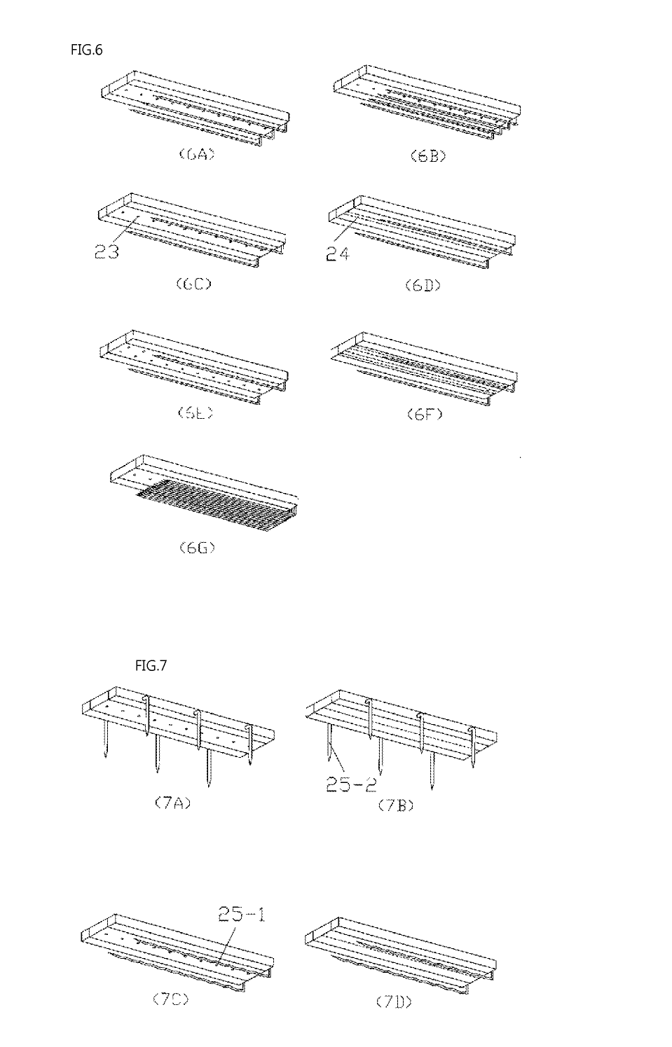

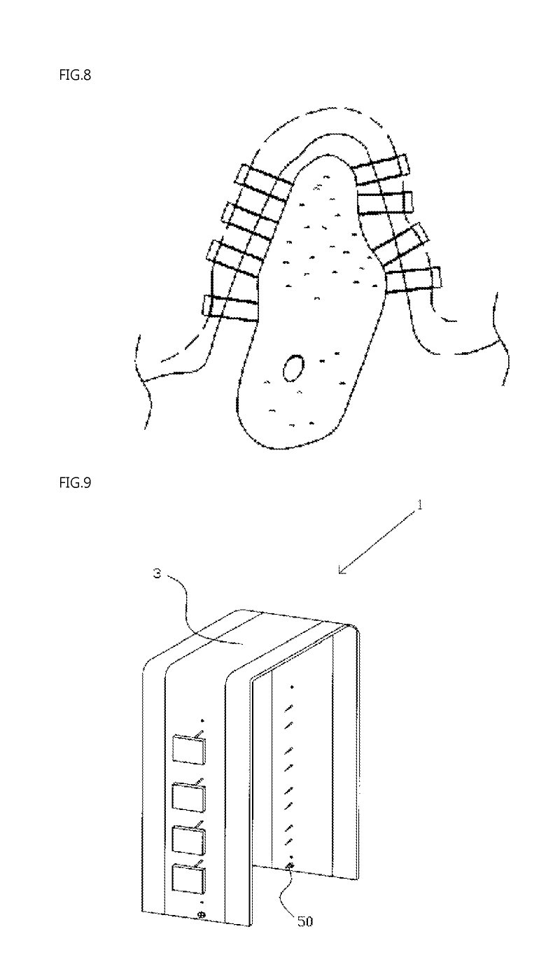

Current invention places the fastening plate for the gum 25 by installing the lower or the side part of the body 200 from the area where implant procedure is to take place from upper part of the gum to the lower part as seen on FIGS. 6 and 7.

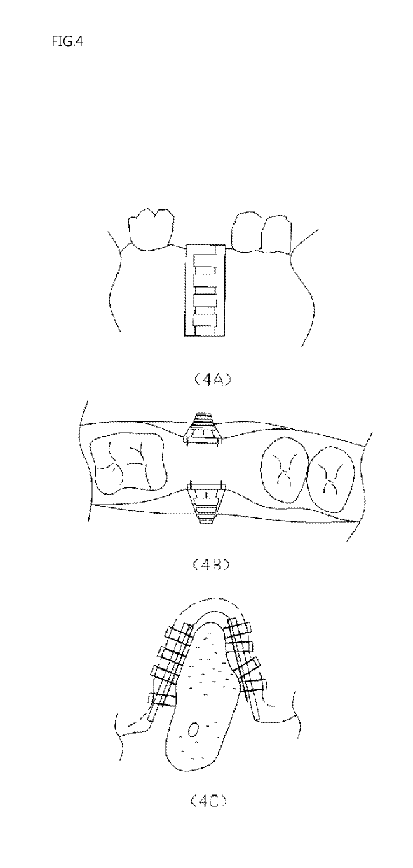

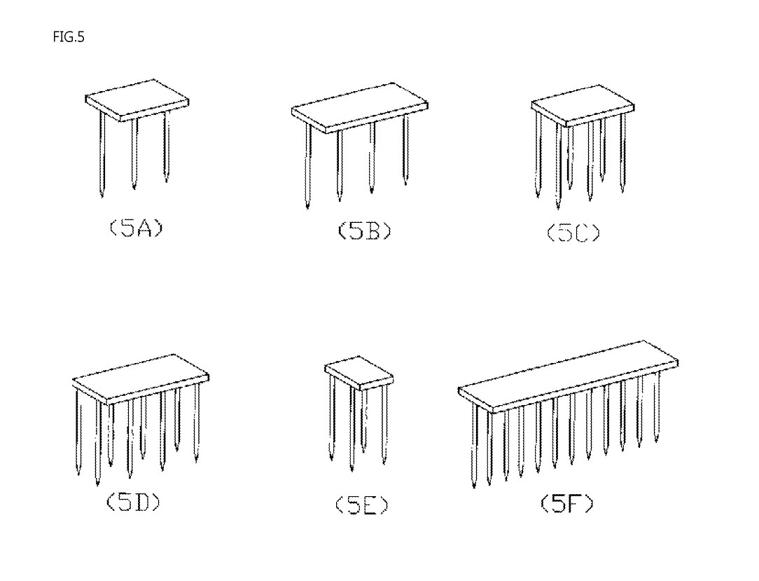

There is one or up to twelve fastening plate for the gum 25 and the above mentioned fastening plate for the gum 25 should be inserted to the gum as seen in FIG. 4.

The current invention aids in the implant procedure that allows the doctor to determine the angle and the location of where implant procedure should take place that reduces the time of the procedure, thereby also minimizing the pain that patient goes through by performing least amount of procedure Implant procedure will take place after the gum incision by the procedure as stated below: the doctor measures the shape of alveolar bone structure by observing the shape of bone structure display device 4. In order to achieve this, several bone structure display device 4 bone structure display device pin fasteners 11 should be inserted on the upper part of the center of the fastening plate 22 or the cutting line 24 located in the central part of the body 200 until the alveolar bone is reached.

After the doctor measures the shape of the alveolar bone structure by observing the shape of bone structure display device 4, angle and the location of where implant procedure should take place is determined and this reduces the time of the procedure. This also minimizes the pain that patient goes through by performing least amount of procedure. Implant procedure will take place after the gum incision.

In this instance, bone structure display device 4 should have one or up to twelve bone structure display device's pin fasteners 11 as shown on FIG. 5. Shape of the alveolar bone and the structure display can be determined according to the location of the bone structure display device 4 in case the alveolar bone comes to contact with the bone structure display device pin fasteners 11. This is possible when the length of bone structure display device and the length of bone structure display device's pin fasteners 11 are proportionate.

As it had been mentioned above, current invention prevents the hole from being created during the implant procedure by patient's alveolar mesiobuccal and the lingual. The procedure is done without having to expose the bones through incision as alveolar bone measurement can be done beforehand.

The current invention can be explained in detail through the examples hereinafter.

### Example 1

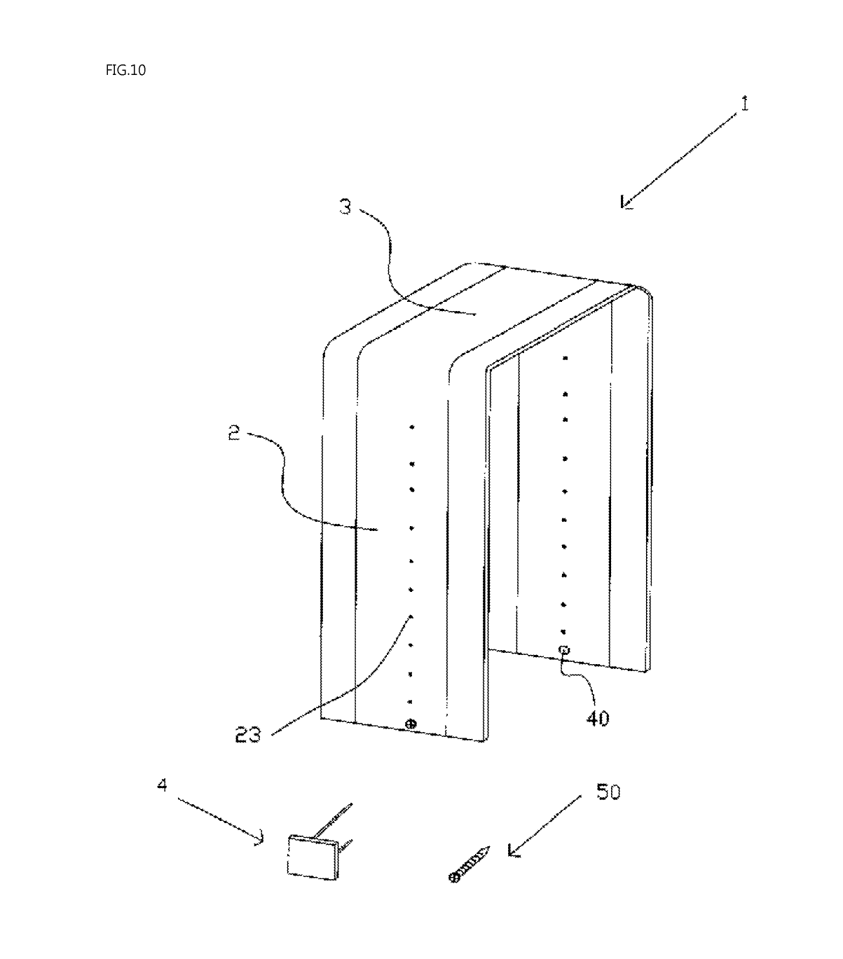

As seen on FIG. 8, multiple bone structure display devices 4 are inserted on the spot where tooth had been removed and thus implant procedure has to take place from the top part of the gum to the bottom. One or up to twelve bone structure display device's pin fasteners 11 are inserted until the alveolar bone has been reached which is located in the lower part of the bone structure display part 10. After examining the shape of the bone structure display device 4, doctor will measure the direction and structure of the alveolar bone and proceeds with the gum incision in the appropriate place to perform the implant procedure. Length of bone structure display device 4 and the bone structure display device's pin fasteners 11 should be proportionate.

### Example 2

As seen on FIG. 4, one or twelve fastening plates for gum insertion are inserted on the spot where tooth had been removed and thus implant procedure has to take place from the top part of the gum to the bottom. Several bone structure display devices 4 should be inserted on top of the pin penetration holes 23 or cutting lines 24 at the center of the body 200. One or up to twelve bone structure display device's pin fasteners 11 are inserted until the alveolar bone has been reached which is located in the lower part of the bone structure display part 10. After examining the shape of the bone structure display device 4, doctor will measure the direction and structure of the alveolar bone and proceeds with the gum incision in the appropriate place to perform the implant procedure. Length of bone structure display device 4 and bone structure display device's pin fasteners 11 should be proportionate.

### Example 3

As seen on FIG. 4, one or twelve fastening plates for gum insertion are inserted on the spot where tooth had been removed and thus implant procedure has to take place from the top part of the gum to the bottom. Several bone structure display devices 4 should be inserted on top of the pin penetration holes 23 or cutting lines 24 at the center of the body 200. One or up to twelve bone structure display device's pin fasteners 11 are inserted until the alveolar bone has been reached which is located in the lower part of the bone structure display part 10. After examining the shape of the bone structure display device 4, doctor will measure the direction and structure of the alveolar bone and proceeds with the gum incision in the appropriate place to perform the implant procedure. Length of the bone structure display device 4 and the bone structure display device's pin fasteners 11 should be proportionate.

### Example 4

As seen on FIG. 4, “∩” shaped fastening plate 1 should be placed on the spot where tooth had been removed and thus implant procedure has to take place from top of the gum to the bottom part. It should be fixed by inserting the fastening plate 1 by putting in the screw 50 on the screw tube 40 and the alveolar bone located in the central lower part on the fastening plate's side 2 which is the fastening plate that had been mentioned above 1.

Multiple bone structure display devices 4 in the multiple pin penetration holes 23 which are installed in the central part of the fastening plate's side 2 which is the fastening plate that had been mentioned above 1 should be inserted until the alveolar bone is reached.

Implant procedure takes place when the doctor observes the shape of the multiple bone structure display devices 4 that are inserted to measure the alveolar bone structure and after the gum incision is done on the right spot. Length of the bone structure display device 4 for this instance should be proportionate.

### Example 5

As seen on FIG. 7, plank shaped fastening plate 100 side 21 should be located on both sides of the gum where implant procedure should take place as the tooth has been removed.

After inserting the screw 50 to secure the screw penetration hole installed on the fastening plate's side which is as mentioned above 21 and in the alveolar bone in order to fasten the fastening plate 1, multiple bone structure display devices 4 are inserted to multiple number of pin penetration holes 23 which are installed with spaces between them at the center of fastening plate's side 21 until the alveolar bone has been reached. Implant procedure takes place when the doctor observes the shape of the multiple bone structure display devices 4 that are inserted to measure the alveolar bone structure and after the gum incision is done on the right spot.

Length of the bone structure display device 4 for this instance should be proportionate.

The following provides detailed explanation according to this invention with diagrams as reference.

FIG. 1 illustrates the alveolar bone structure and general diagram according to the present invention.

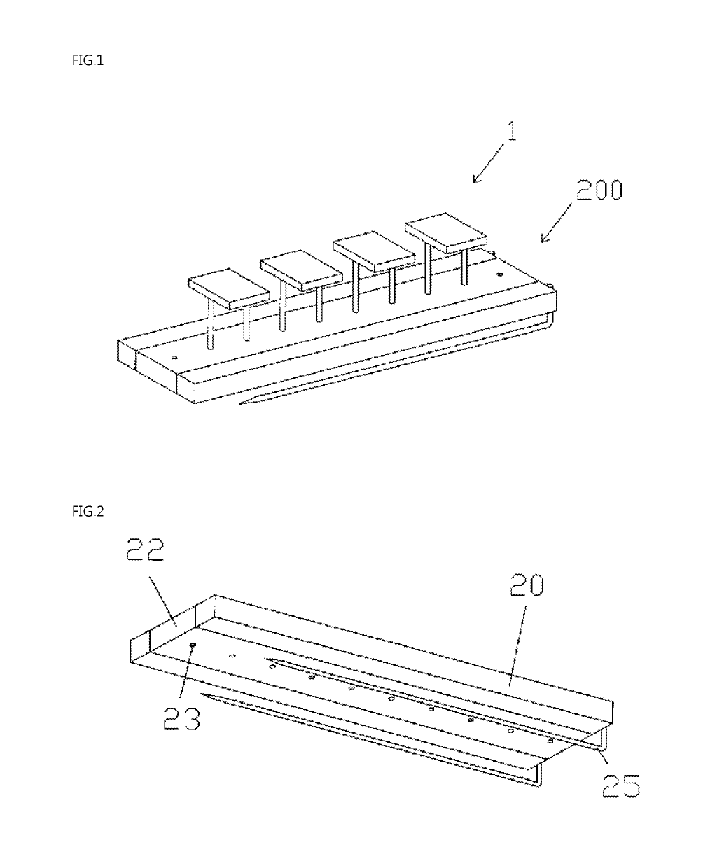

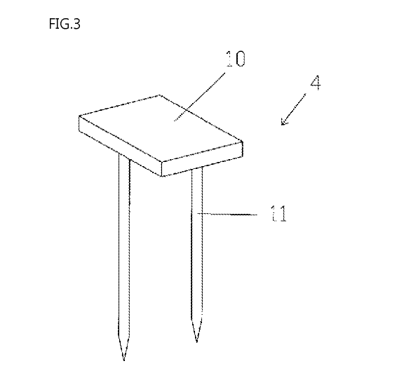

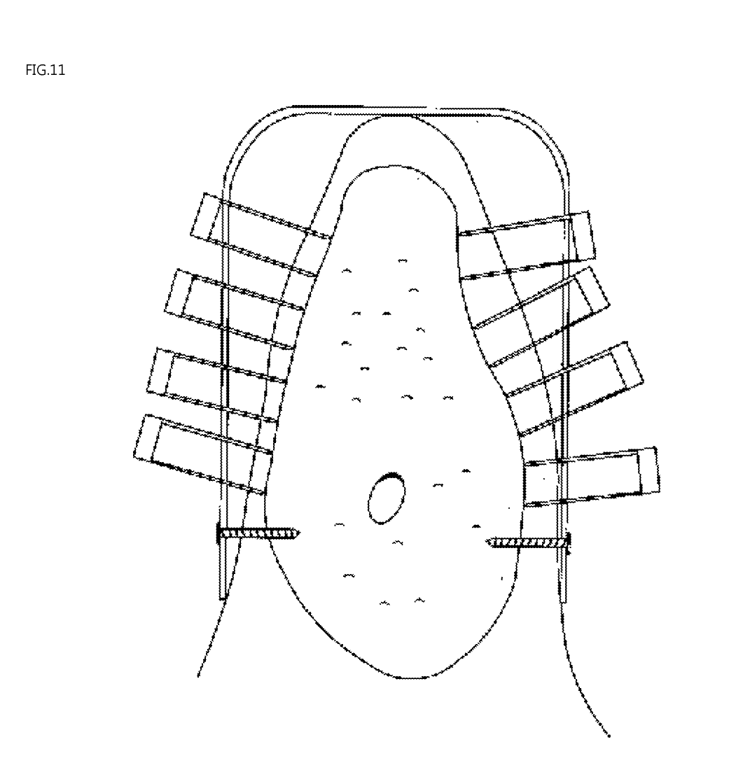

FIG. 2 illustrates alveolar bone structure, direction indicator device and detailed diagram of the body according to the present invention. FIG. 3 illustrates alveolar bone structure, direction indicator device and detailed diagram of the bone structure display device according to the present invention. FIG. 4 illustrates the alveolar bone structure, direction indicator device's usage indicator, frontal constitutional diagram (4)A), detailed plane diagram (4)B), and detailed cross diagram (4)C) according to the present invention. FIG. 5 illustrates another example of alveolar bone structure, direction indicator device and bone structure display device according to the current invention. In FIGS. 6 and 7, another example of alveolar bone structure and direction indicator device's body are illustrated according to the current invention. FIG. 8 illustrates alveolar bone structure, direction indicator device's usage indicator through this invention's bone structure display device according to the current invention. FIG. 9 illustrates the general diagram of alveolar bone structure measurement device according to the current invention. FIG. 10 illustrates the detailed disassembly diagram for alveolar bone structure according to the current invention.

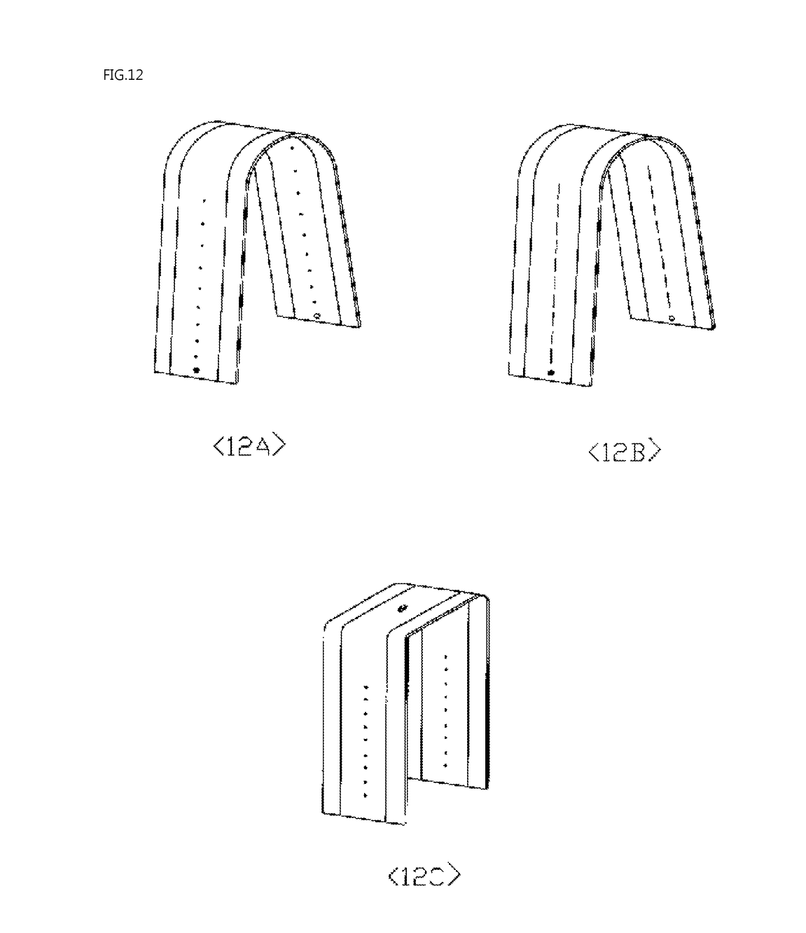

FIG. 11 illustrates the usage indicator for alveolar bone structure's measurement device according to the current invention.

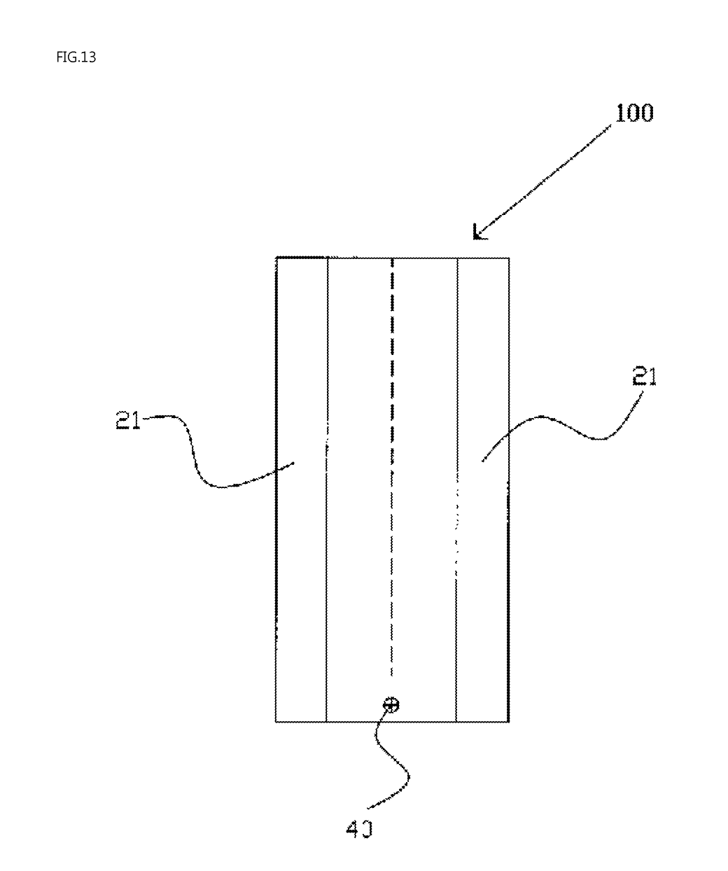

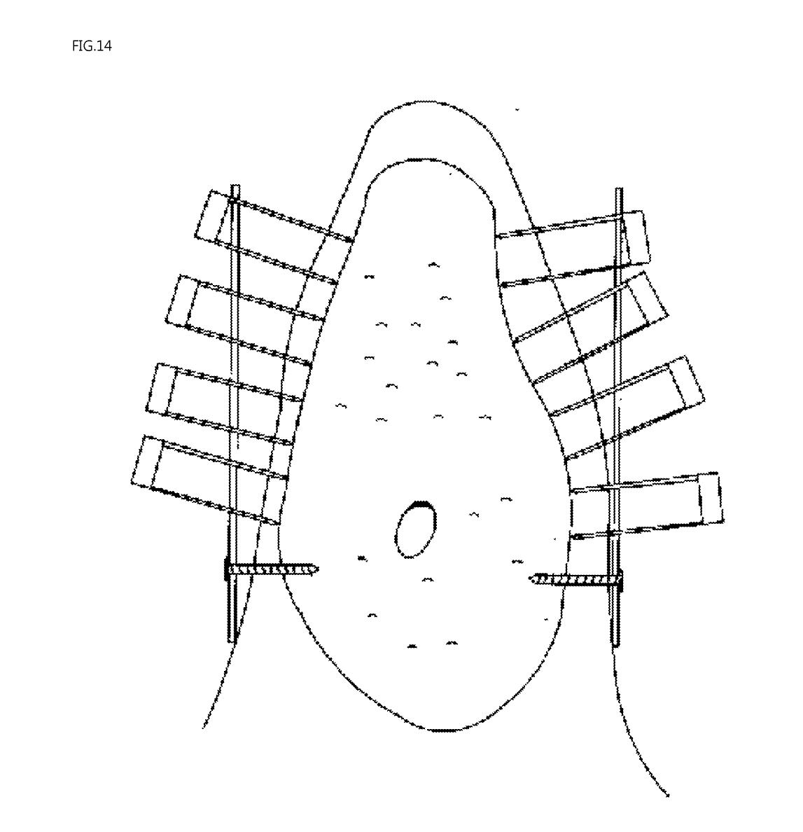

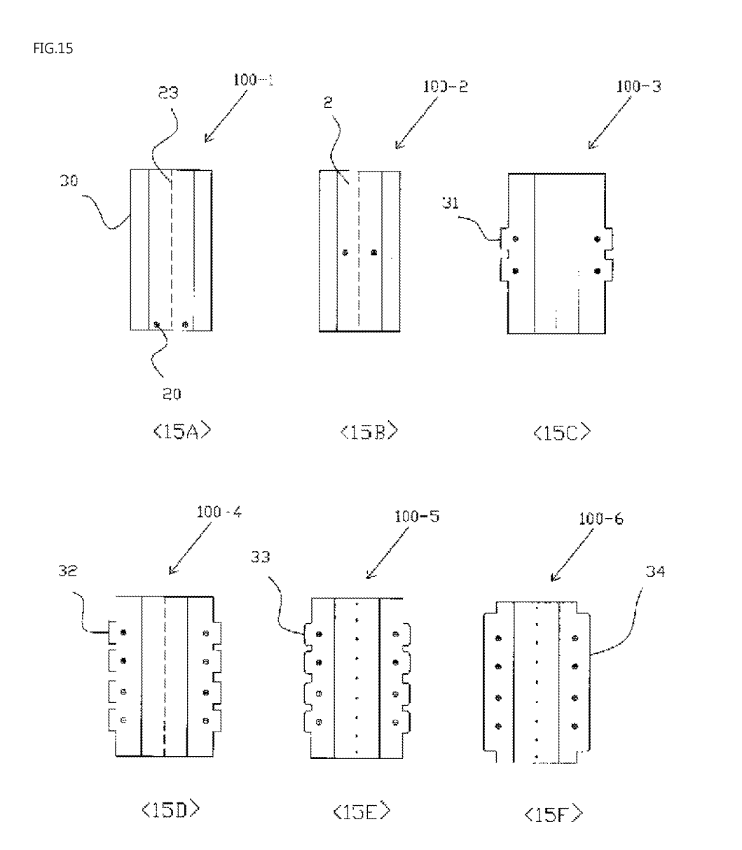

FIG. 12 illustrates another detailed diagram for fastening plate according to the current invention. FIGS. 13 and 14 illustrate another detailed diagram for fastening plate according to the current invention. FIG. 15 illustrates another example of usage indicator for alveolar bone structure's measurement device according to the current invention. The components are as follows: fastening plate 1, 1-1, 1-2, 20, 100, 100-1, 100-2, 100-3, 100-4, 100-5, 1005, fastening plate's side 2, 21 upper part of the fastening plate 3 bone structure display device 4, bone structure display part 10, bone structure display device's pin fastener 11, center of the fastening plate 22, pin penetration hole 23 incision 24, fastening plate for the gum 25, 25-1, 25-2 which is connected to the body 200 fastening plate 20, multiple pin penetration holes 23 located at the center of the fastening plate 22 in the body 200 mentioned above and multiple bone structure display devices 4 inserted in the multiple pin penetration holes 23 as mentioned above.

The body as mentioned above 200 comprises of one or twelve fastening plates for the gum 25 which is connected to the end of the fastening plate 20 and installed in “ [symbol] ” shape as shown in FIGS. 2 and 6.

Fastening plate as mentioned above 20 comprises of center of the fastening plate 22 made from rubber material in the central area and multiple pin penetration holes 23 which are installed in the above mentioned center of the fastening plate 22 with spaces between them when it was installed.

Bone structure display device as mentioned above 4 comprises of one or up to twelve bone structure display device's pin fastener 11 as it is installed in the bottom part of bone structure display part as mentioned above 10 and board shaped bone structure display part as seen on FIGS. 1,3 and 5.

Other body 200 as shown in FIG. 6D and FIG. 6F comprises of the following.

It comprises of fastening plate 20, center of the fastening plate 22 made from rubber material and installed on the center of the fastening plate 20 and the cutting line 24 installed at the end of the center of the fastening plate 22. It is also comprises of one or twelve fastening plates for gum insertion 25 which are connected to the end of the fastening plate 20 as mentioned above in the “┘” shape.

The other body 200 comprises of fastening plate 20, central part of the fastening plate 22 as mentioned above made from rubber materials and located at the center of the fastening plate 20 and several pin penetration holes 23 or cutting lines 24 in the fastening plate's central area 23.

It comprises of one or twelve fastening plates for the gum installed in “ [symbol] ” shape in the fastening plate 20 as mentioned above on both sides with certain amount of space.

Structure of the other body 200 comprises of fastening plate 20, center of the fastening plate made from rubber material and installed on the center 22, and multiple pin penetration holes 23 installed on the center of the fastening plate 22 or cutting line 24 and one or twelve fastening plates for the gum 25-2 which is connected to the end of the fastening plate 20 and installed in “ [symbol] ” shape.

According to in FIGS. 9 and 10, alveolar bone measuring device comprises of the following.

It comprises of fastening plate 1 with the shape of “∩”, upper part of the fastening plate 3 which will be installed in the upper part of the fastening plate 1 as mentioned above, two fastening plates 2 that are installed at both sides of upper part of the fastening plate 3 as mentioned above.

The structure of alveolar bone measuring device comprises of multiple pin penetration holes 23 installed with spaces between them at the center of fastening plate's side 23 multiple bone structure display devices 4 that are inserted in the upper part of the pin penetration holes 23 that are mentioned above, screw penetration holes 40 that are installed below the center of above mentioned fastening plate's side 2, screws 50 that are inserted to above mentioned screw penetration holes 40.

FIG. 12 is another detailed diagram of the fastening plate where it shows that the shape of the upper part of the fastening plate 3, side of the fastening plate 2 and the screw penetration hole 40 position is the same with FIG. 1.

Fastening plate as seen on FIG. 12A and FIG. 12B is the same with the fastening plate shown on FIG. 10. However, in the case of upper part of the fastening plate 3 and two fastening plates 2 that are installed at both sides of upper part of the fastening plate 3, shapes can differ according to the angles that are joined together or when the joint part is closer to the right angle and when the shape is round.

FIG. 12C illustrates the fastening plate that has the same shape with the fastening plate as illustrated on FIG. 9. However, it should be noted herein that screw penetration hole 40 is installed at the lower central part of the side of the fastening plate 2 as depicted in FIG. 9 but in FIG. 12C, it is different in structure as screw penetration hole 40 is located in the upper central part.

FIG. 13 is another form of measuring device for alveolar bones according to the current invention. This is a device installed by extracting the side parts of FIGS. 9 and 10 as mentioned above. Detailed explanation of the structure is stated as below. There are plank-shaped fastening plate 100, side of the fastening plate 21 installed at the side of the above mentioned fastening plate 100, several pin penetration holes 23 in the fastening plate's central area 23 which is located at the center of body as mentioned above 200, and several bone structure display devices 4 that will be inserted on top of the pin penetration holes 23.

There is also the side border that had been mentioned above which is installed in both sides at the edge of the fastening plate's side as mentioned above. Structure of the alveolar bone measuring device also includes screw penetration hole 40 installed at the central lower part of the fastening plate's side 21 which is mentioned above and the screws 50 that are inserted into the screw penetration hole 40.

FIG. 15 is another detailed diagram for fastening plate according to the current invention. This device has extracting the side parts of FIGS. 9 and 10 in the same way as FIG. 13. However, there is a need for further detailed explanation as shape of the screw penetration hole 40 and fastening plate side as seen below.

Structure in FIG. 15A includes the following: board shaped fastening plate, side of the fastening plate 21 installed at both sides of the fastening plate as mentioned above, pin penetration holes 23 which are installed with spaces between them at the center of fastening plate's side and multiple bone structure display devices 4 that are inserted in the upper part of the pin penetration holes 23 that are mentioned above.

There is also the side border 30 that had been mentioned above which is installed in both sides at the edge of the fastening plate's side 21 as mentioned above.

It should be noted that the structure of alveolar bone structure measuring device also includes two screw penetration holes 40 that are installed with spaces between them in the lower center part of the fastening plate's side 21 as mentioned above.

FIG. 15B depicts the board shaped fastening plate and side of the fastening plate installed in both sides of the above mentioned fastening plate, two pin penetration holes 23 installed on the center of the above mentioned fastening plate's side 21. There is also the side border 30 that had been mentioned above which is installed in both sides at the edge of the fastening plate's side 21 as mentioned above. It can be seen that the structure of alveolar bone structure measuring device also includes two screw penetration holes 40 that are installed with spaces between them in the central part of the fastening plate's side 21 as mentioned above.

FIG. 15C depicts the board shaped fastening plate and side of the fastening plate installed in both sides of the above mentioned fastening plate, two pin penetration holes installed on the center of the fastening plate's side as mentioned above. There is also the side border 31 installed at the fastening plate's side 21 as mentioned above on both sides of the central area which are protruding outwards.

It should be noted that the structure of alveolar bone structure measuring device's fastening plate have two screw penetration holes 40 that are installed within the side border 31 installed at the fastening plate's side 21 as mentioned above on both sides of the central area which are protruding outwards.

FIG. 15D depicts the board shaped fastening plate 100-4 and side of the fastening plate 21 installed in both sides of the above mentioned fastening plate 100-4, two pin penetration holes 23 installed on the center of the fastening plate's side 21 as mentioned above.

There is also the side border 32 installed at the fastening plate's side 21 as mentioned above on both sides of the central area which are protruding outwards on the sides with four each.

It should be noted that the structure of alveolar bone structure measuring device's fastening plate have four screw penetration holes 40 that are installed within the four side borders 32 installed at the fastening plate's side 21 as mentioned above on both sides of the central area which are protruding outwards.

FIG. 15E illustrates the same figure with FIG. 15D. However, there is a difference as FIG. 15D as it illustrates square shaped protruding side as the corner of four side borders 32 installed at the fastening plate's side 21 that protrude outwards, with four of them from each side.

FIG. 15E has slightly round shaped side that are protruding outward as the corner of four side borders 32 which are installed at the fastening plate's side 21 that protrude outwards, with four of them from each side.

Structure of alveolar bone structure measuring device fastening plate is as seen on FIG. 15F which has a fastening plate 100-6, fastening plate side 21 installed in each side of the fastening plate mentioned above 100-6, multiple pin penetration holes 23 installed in the central part of the fastening plate's side 21 with spaces in between, side border 34 installed on both sides of the fastening plate as mentioned above 21 and four screw penetration holes 40 installed within the side border 34 which are installed on the side of the fastening plate as mentioned above 21.

### INDUSTRIAL APPLICABILITY

Current invention has following advantages: it increases the accuracy as implant procedure can be performed by checking the shape and the direction of the bone as the direction and the shape of the bone is installed directly in the patient's mouth without having to perform gum incision.

Traditional implant procedures involved too much gum incision but through this invention, it only creates a hole on the spot where implant procedure is to take place which in turn allows less pain and faster healing for the patient. Moreover, this type of less invasive procedure requires expensive CT scanner. Using the scanner may result in incorrect procedure because of the distorted images that scanners can produce but this invention makes up for such disadvantages and poses less economic burden as well.

What is claimed is:

1. A method for measuring alveolar bones by using alveolar bone and direction indicator, comprising inserting a multiple bone structure display device into a spot where tooth had been removed and where implant procedure has to take place from the top part of the gum to the bottom, one or twelve bone structure display device's pin fasteners inserted until the alveolar bone is reached which is located in the lower part of the bone structure display part; after examining shape of the bone structure display device, doctor will measure the direction and structure of the alveolar bone to proceed with gum incision in the appropriate place to perform the implant procedure.

2. A method for measuring alveolar bones by using alveolar bone structure and direction indicator, comprising inserting one or twelve fastening plates for gum insertion into a spot where tooth had been removed and thus implant procedure has to take place from the top part of the gum to the bottom, where several bone structure display devices should be inserted on top of the pin penetration holes or cutting lines in the center of the fastening plate located at the center of the body; one or twelve bone structure display device's pin fasteners are inserted until the alveolar bone has been reached which is located in the lower part of the bone structure display part, and after examining the shape of the bone structure display device, the doctor will measure the direction and structure of the alveolar bone and proceeds with the gum incision in the appropriate place to perform the implant procedure, length of bone structure display device and the bone structure display device's pin fasteners should be proportionate.

3. A method for measuring alveolar bones by using alveolar bone structure and direction indicator, comprising inserting one or twelve fastening plates for gum insertion into a spot where tooth had been removed and thus implant procedure has to take place from the top part of the gum to the bottom, where several bone structure display devices should be inserted on top of the pin penetration holes or cutting lines in the center of the fastening plate located at the center of the body; one or twelve bone structure display device's pin fasteners are inserted until the alveolar bone has been reached which is located in the lower part of the bone structure display part, and after examining the shape of the bone structure display device, the doctor will measure the direction and structure of the alveolar bone and proceeds with the gum incision in the appropriate place to perform the implant procedure, length of bone structure display device and the bone structure display device's pin fasteners should be proportionate.

4. A device for indicating alveolar bone structure and direction, comprising a body, fastening plates for gum insertion, multiple pin penetration holes or cutting lines installed in the center of the fastening plate located at the center of the body, and multiple bone structure display devices inserted in the multiple pin penetration holes or cutting lines as mentioned above and alveolar bone structure and direction indicator comprising of bone structure display device as mentioned above which comprises of bone structure display part shaped similar to a board which includes one or up to twelve bone structure display device's pin fasteners.

5. The device of claim 4, wherein the body comprises the fastening plate and one or twelve fastening plates for gum insertion installed in “ [symbol] ” shape connected to end of lower part of the fastening plate, alveolar bone structure and direction indicator comprised of fastening plate, comprising of fastening plate's center from rubber material on the central area and multiple pin penetration holes or cutting lines installed on the center of the fastening plate with spaces between them when it was installed.

6. The device of claim 4, wherein the body comprises the fastening plate and one or twelve fastening plates for gum insertion installed in “ [symbol] ” shape connected to end of lower part of the fastening plate, alveolar bone structure and direction indicator comprised of fastening plate, comprising of fastening plate's center from rubber material on the central area and multiple pin penetration holes or cutting lines installed on the center of the fastening plate with spaces between them when it was installed.

7. The device of claim 4, wherein the body comprises the fastening plate and one or twelve fastening plates for gum insertion installed in “ [symbol] ” shape connected to end of lower part of the fastening plate, alveolar bone structure and direction indicator comprised of fastening plate, comprising of fastening plate's center from rubber material on the central area and multiple pin penetration holes or cutting lines installed on the center of the fastening plate with spaces between them when it was installed.

8. A device for indicating alveolar bone structure and direction, comprising a board shaped fastening plate, side of the fastening plate installed at both sides of the fastening plate, multiple pin penetration holes or cutting lines which are installed on the side of the fastening plate with spaces between them, multiple bone structure display devices that are inserted in the multiple pin penetration holes, side border installed at both ends of the fastening plate's side as mentioned above, screw penetration hole installed on the side of the fastening plate, screws that are inserted in the screw penetration hole as mentioned above, bone structure display device, board shaped bone structure display and bone structure device indicator's pin fasteners installed in the lower part of bone structure display part.

9. The device of claim 8, wherein the side of the fastening plate installed on the fastening plate, multiple number of pin penetration holes which are installed with spaces between them at the center of fastening plate side, side border installed at both ends of the fastening plate side and the screw penetration hole installed on the lower center part of the fastening plate.

10. The device of claim 8, wherein the fastening plate comprises the side of the fastening plate installed on the fastening plate, multiple number of pin penetration holes which are installed with spaces between them at the center of fastening plate side, side border installed at both ends of the fastening plate side, two screw penetration holes installed on the lower central part of the fastening plate with spaces between them.

11. The device of claim 8, wherein the fastening plate comprises the side of the fastening plate installed on the fastening plate, multiple number of pin penetration holes which are installed with spaces between them at the center of fastening plate side, side border installed at both ends of the fastening plate side, two screw penetration holes installed on the lower central part of the fastening plate with spaces between them.

12. The device of claim 8, wherein the fastening plate comprises the side of the fastening plate installed on the fastening plate, multiple number of pin penetration holes which are installed with spaces between them at the center of fastening plate side, two side borders installed at both ends of the fastening plate side that protrude outwards, two screw penetration holes installed on the lower central part of the fastening plate with spaces between them.

13. The device of claim 8, wherein the fastening plate comprises the side of the fastening plate installed on the fastening plate, multiple number of pin penetration holes which are installed with spaces between them at the center of fastening plate side, four side borders installed at both ends of the fastening plate side that protrude outwards, four screw penetration holes installed on the lower central part of the fastening plate with spaces between them.

14. The device of claim 8, wherein the fastening plate comprises the side of the fastening plate installed on the fastening plate, multiple number of pin penetration holes which are installed with spaces between them at the center of fastening plate side, side borders installed at both ends of the fastening plate side that protrude outwards, four screw penetration holes installed on the lower central part of the fastening plate with spaces between them.

15. A device for measuring alveolar bone structure, comprising a fastening plate with the “∩” shape, upper part of the fastening plate installed on the top of the fastening plate, two fastening plates sides installed in the lower part of both sides of the fastening plate, multiple pin penetration holes installed with spaces between them at the center of fastening plates side, multiple bone structure display devices that are inserted on top of the multiple pin penetration holes, two screw penetration holes installed on the lower center part of the fastening plate, screws that are inserted in the screw penetration hole as mentioned above, board shaped bone structure display device, pin fasteners for bone structure device installed in the lower part of the bone structure display part.

16. The device of claim 15, wherein the fastening plate comprises an upper part of the fastening plate installed on the top of the fastening plate, two fastening plate sides installed on the lower part of both sides of the fastening plate, multiple pin penetration holes installed with spaces between them at the center of fastening plate side, multiple bone structure display devices inserted on top of the multiple pin penetration holes, two screw penetration holes installed on the lower center part of the fastening plate, screws that are inserted in the screw penetration holes, board shaped bone structure display device, pin fasteners for bone structure device installed in the lower part of the bone structure display part.
